(19) United States
(12) Patent Application Publication
(10) Pub. No.: US 2025/0320674 A1
(43) Pub. Date: Oct. 16, 2025

(54) EXTENDABLE BUMPER EXTENSION SYSTEM AND METHOD

(71) Applicant: Bohn and Dawson, Inc, St. Louis, MO (US)

(72) Inventor: Bradley Allen Watson, St. Louis, MO (US)

(73) Assignee: Bohn and Dawson, Inc, St. Louis, MO (US)

(21) Appl. No.: 18/631,537

(22) Filed: Apr. 10, 2024

(51) Int. Cl. E01F 9/662; B60Q 1/26; B60Q 1/50; E01F 9/615

(52) U.S. Cl. CPC E01F 9/662; B60Q 1/2657; B60Q 1/2661; B60Q 1/2692; B60Q 1/545; E01F 9/615

(57) ABSTRACT

A safety system for a vehicle. The vehicle has a bumper and a power source. The safety system includes a hollow extension configured to connect to the bumper parallel to the bumper and substantially in same vertical plane of the bumper, the extension has a length of about as long as the bumper. An actuator is connected to the hollow extension and to an extendable arm contained at least in part in the hollow extension. A switch is communicatively connected to the actuator and the power source. The switch operates to activate the actuator to selectively either protrude at least a portion of the extendable arm beyond the hollow extension when resident in the hollow extension and retract the extendable arm into the hollow extension when protruded. The safety system may also include lights of the extendable arm that operate “on” when the extendable arm protrudes.

### TECHNICAL FIELD

The present disclosure relates generally to transportation and safety, and more particularly, relates to an extension for an extendable safety bumper of transportation vehicles.

### BACKGROUND

Moving vehicles, such as cars, trucks, vans, and other roadway vehicles and the like, are typically equipped with vehicle bumpers. A vehicle parked in a road shoulder can nevertheless present hazard even with conventional vehicle bumpers. It is moreover particularly dangerous to someone outside of the parked vehicle. Vehicle bumpers conventionally extend only along width of the vehicle. There is nothing for shielding a person standing or walking along side of the vehicle.

In the past, traffic cones, reflectors, and similar devices have at times been employed to set along the side of a parked vehicle. Also, vehicles, such as police or first responder vehicles, may have lights or sirens that make the vehicles more apparent. Nevertheless, these safety implements do not provide much protection to a person outside of the vehicle.

By some measures, about 23,000 deaths occurred because of parking on a road shoulder. This can particularly impact emergency responders who are outside of vehicles tending to emergencies. Police, fire, ambulance, and other emergency responders are especially vulnerable when outside of vehicles and tending to an emergency.

It would therefore be advantageous to provide extension systems and methods for extending safety devices beyond vehicle width. It would be particularly advantageous to provide sturdy deflection systems and methods that would shield those alongside the vehicles. It would further be an advantage to automate such systems and methods for ready deployment.

### SUMMARY

An embodiment of the invention is a system for shielding alongside of a vehicle. The system includes a bracket connected to the vehicle, a hollow cylinder connected to the bracket, an actuator connected to the hollow cylinder, an extendable arm connected to the actuator, and a switch connected to the actuator for controlling the extendable arm to selectively extend and retract, respectively.

Another embodiment of the invention is a safety system for a vehicle having a bumper and a power source. The safety system includes a hollow extension configured to connect to the bumper parallel to the bumper and substantially in same vertical plane of the bumper, the extension has a length of about as long as the bumper, an actuator connected to the hollow extension, an extendable arm connected to the actuator and contained at least in part in the hollow extension, and a switch communicatively connected to the actuator and the power source. The switch operates to activate the actuator to selectively either protrude the extendable arm out of the hollow extension when resident in the hollow extension and retract the extendable arm when protruded from out of the hollow extension.

Yet another embodiment of the invention is a method of safely shielding alongside a vehicle. The method includes connecting an ancillary bumper to the vehicle, wherein the ancillary bumper is of length about same as width of the vehicle and includes an extendable arm, and selectively extending the extendable arm of the ancillary bumper.

Another embodiment of the invention is a method of manufacture of a shield alongside of a vehicle. The vehicle includes a power source. The method of manufacture includes forming a bracket configured for connection to the vehicle, connecting a hollow cylinder to the bracket, connecting a linear actuator to the hollow cylinder within the hollow cylinder, connecting an extendable arm to the linear actuator within the hollow cylinder, and communicatively connecting a switch to the power source and the linear actuator. The switch toggles between extension of the linear actuator and retraction of the linear actuator, respectively, thereby positioning the extendable arm protruding from the hollow cylinder or residing within the hollow cylinder, respectively

### BRIEF DESCRIPTION OF THE DRAWINGS

The present invention is illustrated by way of example and not limitation in the accompanying figures, in which like references indicate similar elements, and in which:

FIG. 1 illustrates a system for addition to a vehicle to selectively shield alongside of the vehicle, with an extension arm retracted, according to certain embodiments of the invention;

FIG. 2 illustrates an exploded view of a system for addition to a vehicle to selectively shield alongside of the vehicle, according to certain embodiments of the invention;

FIG. 3 illustrates an end view of a system that includes a bumper extension of FIG. 1 or 2, with an extendable arm, according to certain embodiments of the invention;

FIG. 4 illustrates a system for selective shielding in use in a vehicle on side of a road, according to certain embodiments of the invention;

FIG. 5 illustrates a system for control of an extendable arm in a bumper extension of FIGS. 1-4, according to certain embodiments of the invention; and

FIG. 6 illustrates a method of operation of the systems of FIGS. 1-5 in use in a vehicle, such as a police or emergency vehicle, according to certain embodiments of the invention.

### DETAILED DESCRIPTION

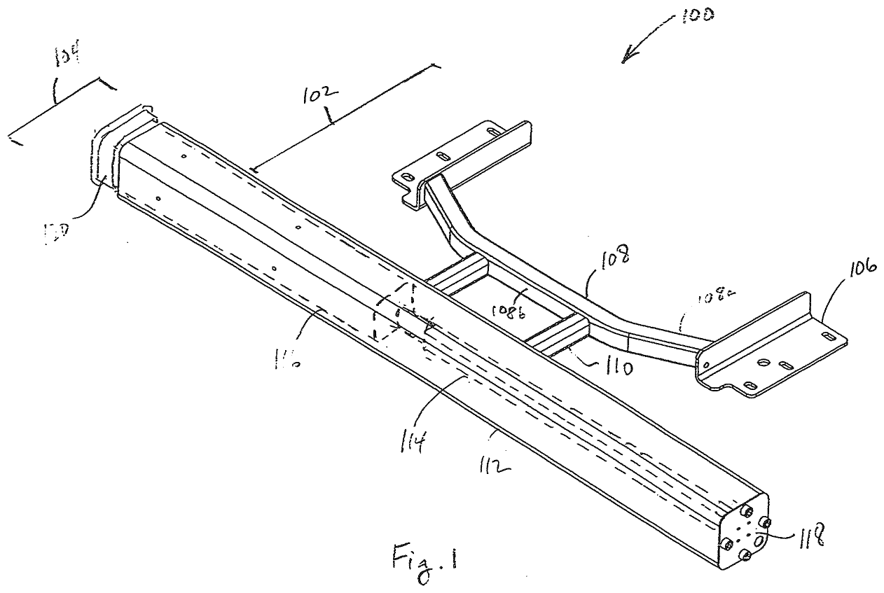

Referring to FIG. 1, a nonexclusive embodiment of a system 100 includes a bracket 102 connected to an extender 104. The bracket 102, for non-exclusive example, may include one or more pad, such as two pads 106, for connection to a bumper of a vehicle (not shown in FIG. 1). The extender 104, for non-exclusive example, may be an elongate structure extending in generally same plane and parallel to the pads 106.

The bracket 102, for non-exclusive example, may also include a generally arcuate member 108 connected between the pads 106. The member 108 may, for non-exclusive example, form three sides of a semi-octagon, with wing members 108a connected to respectively to each pad 106 and a central member 108b connected to the wing members 108a. In further non-exclusive example, the central member 108b may connect to one or more, such as two, for example, extending struts 110. In the non-exclusive example, the struts 110 may connect to the extender 104.

The extender 104, for non-exclusive example, includes a substantially square cross-section, hollow cylinder 112. An end cap 118 in the non-exclusive example is connected to an end of the cylinder 112. An actuator 114, in the non-exclusive example, is within the cylinder 112 and connected to the end cap 118. In the non-exclusive example, the actuator 114 is connected to an extending arm 116 that slides within the cylinder 112 to position at least partially outward from the cylinder 112, as actuated by the actuator 114. A safety cap 120 may, for non-exclusive example, connect to an end of the extending arm 116, opposite the actuator 114.

In certain non-exclusive embodiments, the actuator 114 is an electrically activated piston. A compressor (not shown in FIG. 1) may communicatively connect to the actuator 114. A switch (not shown in FIG. 1) may electrically connect the compressor to a battery (not shown in FIG. 1), such as for example a vehicle's battery. Moreover, in certain non-exclusive embodiments, the extending arm 116 (and/or other features or elements) of the system 100 may be fitted or connected to lights (not shown in FIG. 1), such as for example one or more LED signal lights. The lights may be powered by the vehicle battery or otherwise, and may selectively turn on and off to flash and when the extending arm is extended (on) or retracted (off).

In operation, the actuator 114 is triggered (such as via switch) to selectively extend the extending arm 116 outwardly beyond end of the cylinder 112. The extending arm 116 thereby shields a side of a vehicle for safety. The actuator 114 is then triggered (such as via switch) to selectively retract the extending arm 116 to position shown in FIG. 1.

In the non-exclusive embodiments, the pads 106, member 108, struts 110, cylinder 112, end cap 118, and extending arm 116 may each be comprised of steel, iron, composite, or other suitable strong materials. The bracket 102 may be welded, molded, machined, or otherwise formed. The actuator 114 may be a linear actuator that provides sturdy positioning of the extending arm 116 when extended from the cylinder 112. The safety cap may be formed or molded of plastic, metal, composite, or other materials.

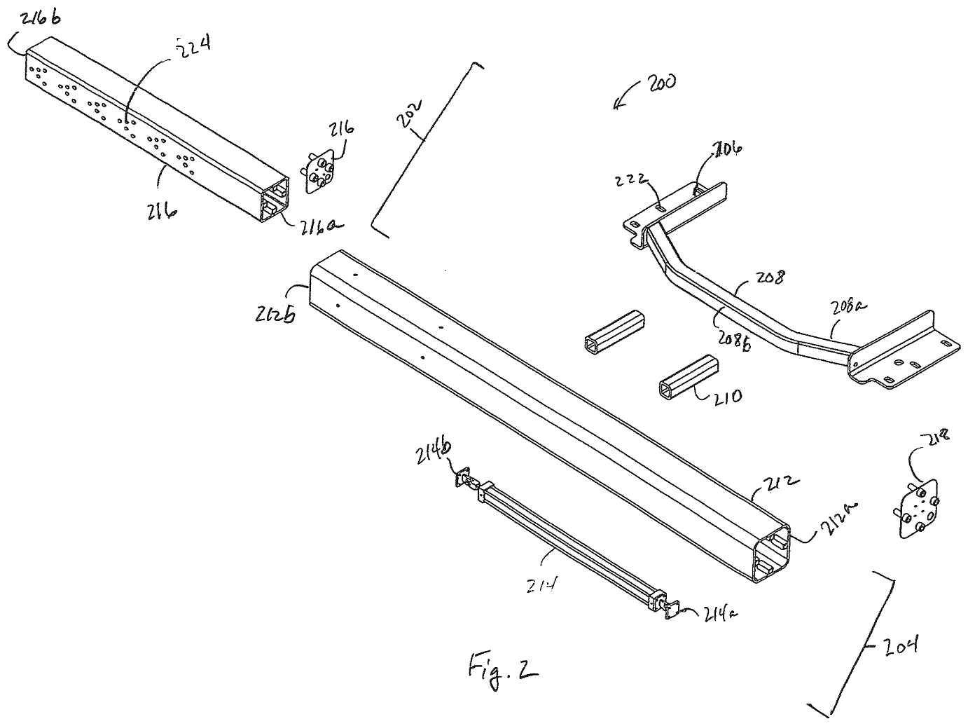

Referring to FIG. 2, a nonexclusive embodiment of a system 200 includes bracket components 202 and extendable bumper components 204. The bracket components 202 include pads 206, such as one or more support plates. The pads 206 are planar extended plates with bolt holes or other devices to allow attachment of the pads 206 to a vehicle bumper or frame as further described. The plates 206, respectively, are connected to wing struts 208a, such as one or more square tubular or other frame length. The wing struts 208a, if more than one, may be connected at end opposite the plates 206, by a center frame 208b, such as a square tubular or other frame length or lengths. Frame extenders 210, such as one or more square tubular or other frame length or lengths, may connect to the center frame 208b, and as further described are connected to a hollow segment 212, such as a square or other cross-section tube.

The segment 212 of the extendable bumper components has length that is about the same as width of a vehicle or vehicle rear bumper. The bracket components 202 are sized to attach the segment 212 to the vehicle bumper or frame. Materials and structures of the bracket components 202 securely connect to the vehicle bumper or frame to the extendable bumper components 204, sufficient for deflecting or avoiding hazards, much as an ancillary rear bumper of a vehicle.

The extendable bumper components 204 include the segment 212 containing an actuator 214. The actuator 214 may be a linear actuator, such as a compression piston, screw, or other. The actuator 214 is positioned within an end 212a of the segment 212, and retained in position inside the segment by connection of an actuator first end 214a to an end cap 218. The end cap 218 is connected to a first end 212a of the segment 212 and thereby retains the actuator 214 in position in the segment 212. An extension segment 220 is sized in cross-section about slightly smaller than the inner hollow of the segment 212. The extension segment 216 is sized to extend in length, within the segment 212 from an actuator second end 214b, when the actuator 214 is compressed and not extended (as shown in FIG. 2), and partially extending beyond the second end 212b of the segment 212, outward from the second end 212b when the actuator 214 is actuated and extended (not shown in FIG. 2). An extension end cap 215 connects to a first extension segment end 216a. An actuator second end 214b connects to the first extension segment end 216a. The extension segment 216 may be formed with, connected to, or otherwise attached or fixed with one or more lights 224, such as LED lights, auto lamps, reflectors, or otherwise. Although not shown in detail in FIG. 2, a safety cap (such as the safety cap 120 of FIG. 1) may be connected to a second extension segment end 216b.

In operation, the bracket components 202 are combined substantially as shown in FIG. 1 and the extendable bumper components 204 are combined therewith substantially as shown in FIG. 1. The bolt holes 222 or other attachment mechanisms accept bolts, rivets, or other connectors, with applicable nuts or other, allow connection of the system 200 to a vehicle bumper or frame. In such connection, the system 200 extends lengthwise beyond a bumper or frame of a vehicle.

During transit of the vehicle, not in use or not desired, the actuator 214 is compressed, and the extension segment 216 lodges within the segment 212. When desired, the actuator 214 is extended and the extension segment 216 protrudes at least partially beyond the segment 212 at the second end 212b. In certain nonexclusive embodiments, the protrusion of the extension segment 216 on activated extension of the actuator 214 is sufficient to protect along side of a vehicle to which the system 200 is connected, such as to shield passage along the side of the vehicle where a person may stand or walk. The actuator 214 may be automated, such as via switch, software, circuit, or otherwise, to cause the extension segment 216 to protrude as desired and to cause the extension segment 216 to retract in the segment 212 as desired.

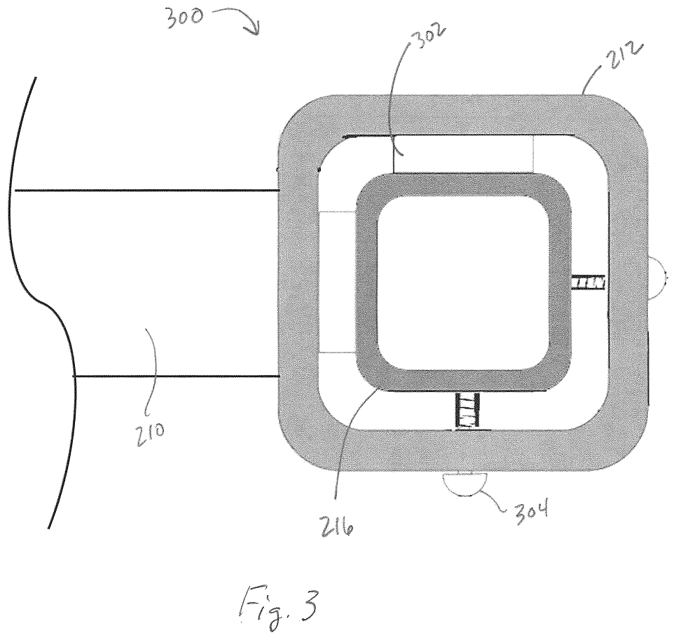

Referring to FIG. 3, in conjunction with FIGS. 1 and 2, an end 300 of the second end 212b of the hollow segment 212 includes the extension segment 216 within the segment 212. One or more wear plate 302 is connected internally of the segment 212 to guide the extension segment 216 in extension and retraction. One or more screw 304 is also connected to the segment 212 and extends through the segment 212 against the extension segment 216. The one or more screw 304 allows adjustment of the centering of the extension segment 216 in the hollow segment 212.

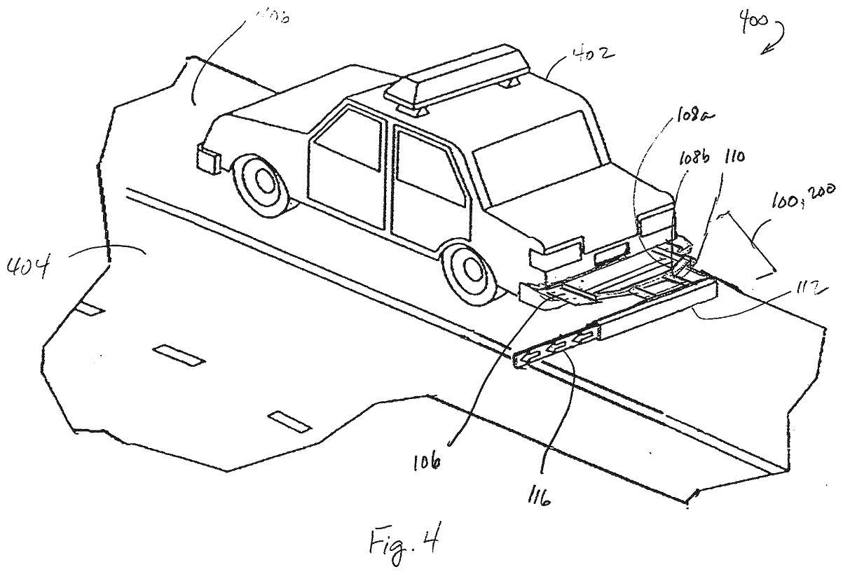

Referring to FIG. 4, in conjunction with FIGS. 1-3, a safety system 400 includes a system 100 (or 200 of FIG. 2). A vehicle 402 is parked on a shoulder 406 of a road 404. The system 100 includes pads 106 connected to wings 108a. The wings 108a are connected to a midsection 108b. Struts 110 are connected to the midsection 108b. The struts 110 are also connected to a hollow cylinder 112 as additional bumper. The cylinder 112 contains an actuator (not shown) activated to extend the extending arm 116 protruding outwardly along side of the vehicle 402. The arm 116 as so protruding shields along the side of the vehicle 402, such as for when a person is standing or walking along the driver side of the vehicle 402.

In operation of the system 400, the arm 116 is retained within hollow of the cylinder 112 when not in use. When extension of the arm 116 is desired, the actuator is activated to extend and protrude the arm 116 from the cylinder 112. When the arm 116 is desired to remain within the cylinder 112, the actuator is activated to contract the arm 116.

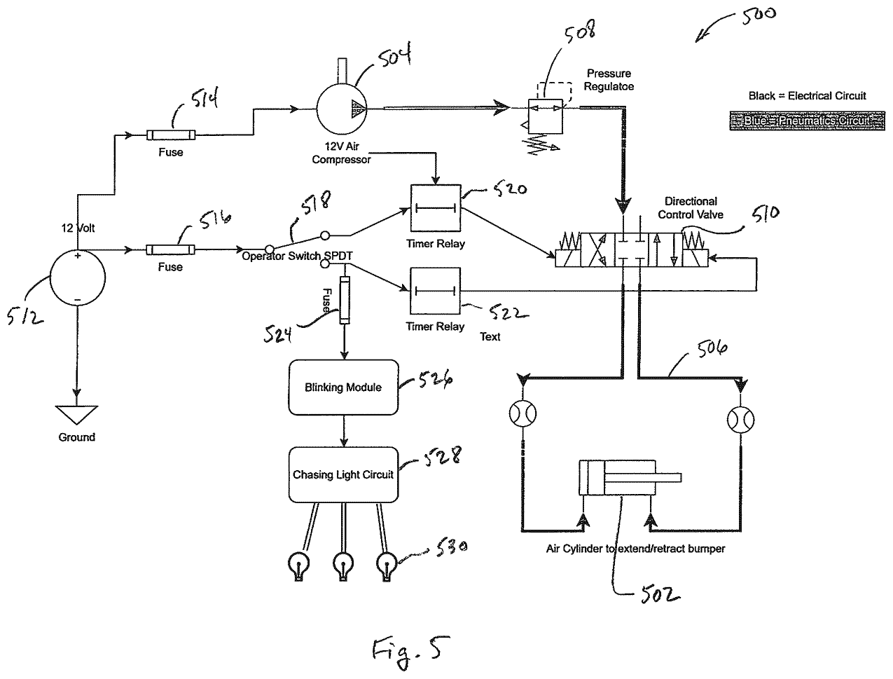

Referring to FIG. 5, a system 500 controls the actuator to selectively protrude and selectively retract the arm 116 in the cylinder 112. The system 500 includes an actuator 502, such as for nonexclusive example an air piston or cylinder. In nonexclusive examples, the actuator 502 is fed a fluid 506, such as air, oil, or other, from a compressor 504. The fluid 506, in nonexclusive example, passes from the compressor 504 to a regulator 508 and then to a directional control valve 510, prior to delivery to the actuator 502. Although the actuator 502 is hydraulically activated in the nonexclusive example, other means of similar activation to extend the arm 116 are possible, such as screw mechanism or other.

Further in nonexclusive example, the compressor 504 and control via the control valve 510 are electrically activated. A battery 512, such as a 12 volt vehicle battery or other power source, communicatively connects to a fuse 514. The fuse 514 communicatively connects to the compressor 504. The battery 512 also connects to a fuse 516. The fuse 516 connects to a switch 518. The switch 518 (shown in “off” or retracted state of the arm 116) communicatively connects to a timer relay 520. The timer relay 520 communicatively connects to the directional control valve 510.

In the nonexclusive example, the switch 518 when manually (or automatedly, if so implemented in the embodiment) activated to “on” (not shown in FIG. 5) communicatively connects to a timer relay 522. The timer relay 522 communicatively connects to the directional control valve 510 to activate the actuator 502 to extend the arm 116. Concurrently, the switch 518 communicatively connects to a fuse 524. The fuse 524 is connected to a blinking module 526, such as a programmed processor, application specific integrated circuit, or other circuit. The blinking module 526 operates to selectively turn on and off a light circuit 528 communicatively connected to the blinking module 526. The light circuit 528 is communicatively connected to lamps 530, such as LEDs, bulbs, or other.

In operation, the switch 518 is operated to “on” or “off” as desired, programmed, automated, or as otherwise operated. When “on,” the control valve 510 passes fluid 506 to the actuator 502 to lengthen the actuator 502. The actuator 502 connects to the arm 116 and thereby extends the arm 116 a distance, such as for nonexclusive example, about two fee, from the cylinder 112, to shield alongside a vehicle. The arm 116 as extended may include lamps 530 which, via the blinking module 526 and the light circuit 528, may flash in sequence, at once, or as otherwise implemented. When “off,” the control valve 510 passes fluid 506 to the actuator 502 to shorten the actuator 502. The actuator 502 connected to the arm 116 retracts the arm 116 to the cylinder 112. The switch 518 in “off” position does not power the blinking module 526, light circuit 528 and lamps 530. So, there is not any lighting when the arm 116 is retracted.

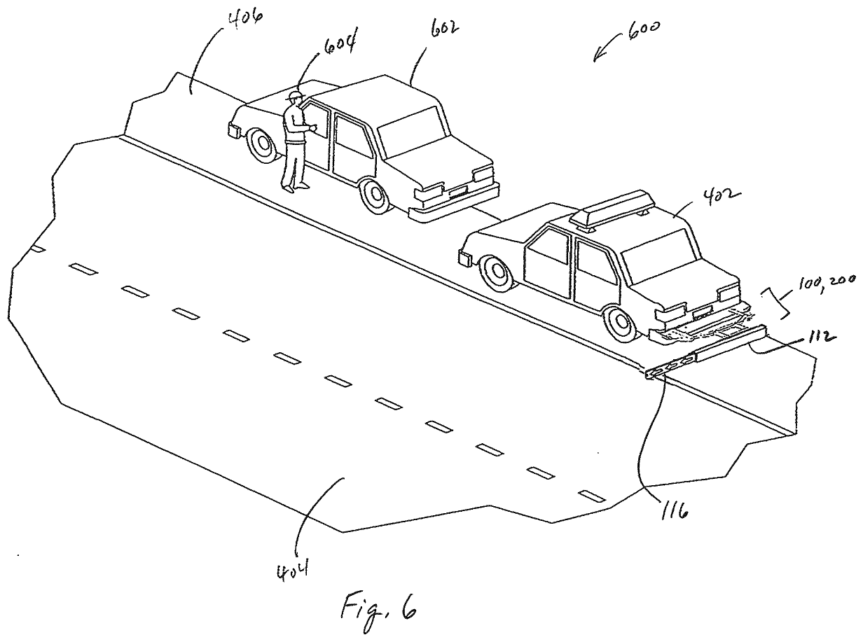

Referring to FIG. 6, in conjunction with FIGS. 1-5, a vehicle 402 includes the safety system 100 or 200. The arm 116 is extended from the cylinder 112 because the switch 518 (not shown in FIG. 6) is switched to “on.” The vehicle 402 has another passenger vehicle 602 stopped on the shoulder 406 of the road 404. The arm 116 so extended shields a person 604 alongside the vehicles 402, 602 on the shoulder 406.

Numerous alternatives and variations are possible in the foregoing embodiments. Although a hydraulically activated actuator has been described, any mechanism, such as a screw or other mechanics, are possible as actuator. The control electrical circuit similarly may be different than described, such as for nonexclusive example an optic system, radio frequency, Bluetooth™, or other control may be employed. The arm when extended can be longer or shorter in protrusion from the cylinder. The systems may be installed in a conventional bumper or frame of the vehicle, and may be connected to front or rear elements of the vehicle. A wide variety of vehicles can benefit from the addition of the systems, and the systems are believed to be especially effective in emergency or first responder situations. Lights or other signals may be included in the arm and/or otherwise in the systems. Operations of the lights on and off, as applicable, may be varied. Methods of operation of the systems are exemplary and other methods are included. Materials of the systems are widely varied and can include steel, iron, metal, composite, hard plastic, and other materials. Manufacture of the systems may include welding, molding, bolting, and others and combinations.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for shielding alongside of a vehicle, comprising:
a bracket connected to the vehicle;
a hollow cylinder connected to the bracket;
an actuator connected to the hollow cylinder;
an extendable arm connected to the actuator;
a switch connected to the actuator for controlling the extendable arm to selectively extend and retract, respectively.

2. The system of claim 1, further comprising:
a circuit communicatively connected to the switch and configured to communicatively connect to a power source;
a compressor communicatively connected to the power source and the actuator;
wherein the compressor activates the actuator to selectively extend and retract the extendable arm, as controlled by the switch.

3. The system of claim 1, further comprising:
a light connected to the extendable arm and communicatively connected to the switch;
wherein the light is powered on when the switch activates the actuator to extend the extendable arm.

4. The system of claim 2, further comprising:
a light connected to the extendable arm and communicatively connected to the switch;
wherein the light is powered on when the switch activates the actuator to extend the extendable arm

5. The system of claim 1, wherein the bracket is configured to connect to either a vehicle bumper and a vehicle frame.

6. The system of claim 2, wherein the bracket is configured to connect to either of a vehicle bumper and a vehicle frame.

7. The system of claim 4, wherein the bracket is configured as an aftermarket add-on to a vehicle.

8. A safety system for a vehicle having a bumper and a power source, comprising:
a hollow extension configured to connect to the bumper parallel to the bumper and substantially in same vertical plane of the bumper, the extension has a length of about as long as the bumper;
an actuator connected to the hollow extension;
an extendable arm connected to the actuator and contained at least in part in the hollow extension; and
a switch communicatively connected to the actuator and the power source;
wherein the switch operates to activate the actuator to selectively either protrude the extendable arm out of the hollow extension when resident in the hollow extension and retract the extendable arm when protruded from out of the hollow extension.

9. The system of claim 8, wherein the actuator is a linear actuator and when activated extends at least about two feet.

10. The system of claim 9, wherein the linear actuator and when activated protrudes the extendable arm at least about two feet beyond the hollow extension.

11. The system of claim 8, further comprising:
a compressor communicatively connected to the actuator and the switch;
wherein the switch, when “on,” powers the actuator to protrude the extendable arm from the hollow extension;
wherein the switch, when “off,” powers the actuator to retract the extendable arm in the hollow extension.

12. The system of claim 11, further comprising:
a light connected to the extendable arm;
wherein the switch, when “on,” powers the light on;
wherein the switch, when “off,” powers the light off.

13. The system of claim 12, further comprising:
a bracket connected to the hollow extension and configured for connecting to the bumper;
wherein, when the bracket is connected to the bumper, the hollow extension acts as barrier to shield the vehicle.

14. The system of claim 13, wherein the extendable arm, when protruding from the hollow extension, acts as a barrier to shield alongside the vehicle on a driver's side of the vehicle.

15. The system of claim 14, wherein the bracket, the hollow extension, and the extendable arm are sufficient to withstand a roadway impact.

16. A method of safely shielding alongside a vehicle, comprising:
connecting an ancillary bumper to the vehicle, wherein the ancillary bumper is of length about same as width of the vehicle and includes an extendable arm;
selectively extending the extendable arm of the ancillary bumper.

17. The method of claim 16, wherein the extendable arm is actuated to protrude in the ancillary bumper sufficient to limit passage along side of the vehicle.

18. A method of manufacture of a shield alongside of a vehicle, the vehicle includes a power source, comprising:
forming a bracket configured for connection to the vehicle;
connecting a hollow cylinder to the bracket;
connecting a linear actuator to the hollow cylinder within the hollow cylinder;
connecting an extendable arm to the linear actuator within the hollow cylinder; and
communicatively connecting a switch to the power source and the linear actuator;
wherein the switch toggles between extension of the linear actuator and retraction of the linear actuator, respectively, thereby positioning the extendable arm protruding from the hollow cylinder or residing within the hollow cylinder, respectively.

19. The method of manufacture of claim 18, further comprising:
connecting a light to the extendable arm and the switch.

20. The method of manufacture of claim 19, wherein the switch toggles power to the light “on” upon extension of the linear actuator and “off” upon retraction of the linear actuator.
